(19) United States
(12) Patent Application Publication
(10) Pub. No.: US 2007/0108179 A1
(43) Pub. Date: May 17, 2007

(54) COOKING OVEN

(76) Inventor: Robert Stickley Hines JR., Unicoi, TN (US)

Correspondence Address: Donald W. Spurrell, P.O. Box 970, Johnson City, TN, 37605, US

(21) Appl. No.: 11/347,982

(22) Filed: Feb. 6, 2006

Related U.S. Application Data
(60) Provisional application No. 60/661,618, filed on Mar. 14, 2005.
(60) Provisional application No. 60/693,882, filed on Jun. 24, 2005.

(51) Int. Cl. F27D 11/00

(52) U.S. Cl. 219/400

(57) ABSTRACT

A cooking structure which provide for two or more side-by-side ovens separated by vertical, movable, hinged partition(s) whereby the oven structure may function as one large oven or as two or more smaller independent ovens, wherein for each oven a tangential fan blows air substantially evenly over upper electrical heating elements strung generally from side-to-side of the oven, wherein a flow director functions as a radiant heat shield which is operator movable to either expose to or occlude from the oven cooking chamber to direct radiation from its heating elements depending on the need to roast, bake, or broil the food product. Also provided are lower electrical heating elements positioned below a ceramic cooking surface for ensuring evenness of radiant heat transfer therefrom. Also provided for is operator controlled top vs. bottom heating using a slide control that reciprocally affects the duty cycle of the top and bottom electrical heating elements, further allowing precision baking control.

This application claims priority under 35 U.S.C. 119(e)(1) based on Applicants Provisional U.S. patent application Ser. No. 60/661,618 filed Mar. 14, 2005 and titled “CONCEPT DESIGN FOR COMMERCIAL STYLE HOME BAKING DEVICE/OVEN”.

### BACKGROUND OF THE INVENTION

1. Field

The present invention is directed to electrically heated convection baking ovens and the like and particularly concerns, in preferred embodiments, operator control of radiant heat emanating from heating elements and directed down into the oven cooking chamber, specially constructed and functional heated air circulating means for providing more uniform heat transfer throughout the cooking chamber, an upper heating element and a lower heating element with a ceramic or metal heat sink, specially designed partition or divider means for quickly and easily converting the oven cooking chamber from a single chamber to multiple chambers and vise versa, and in a most preferred embodiment uniquely functional electrical control means is provided for regulating heat output of the upper and lower heating elements in a reciprocal manner so as to accurately regulate the temperature of a particular area—sweet spot—within the oven cooking chamber which is most desirable for a particular product.

2. Prior Art

Conventional home ovens for the past 100 years have retained the basic cube configuration for the oven cooking chamber which is typically provided with horizontal interposed cooking racks. Other than the addition of “convection” provided by fan means and the substitution of electronic for electromechanical controls, little has changed. This basic configuration leaves considerable room for improvement.

Much oven usage involves baking, roasting or broiling of smaller size or number of food products whereby utilization of the large standard oven cavity becomes energy inefficient. Attempts at simultaneous precision baking on multiple racks is usually futile because of the unevenness in heat transfer excepting perhaps for ovens with “pure” or “European style” convection. Simply spoken, most ovens have one “sweet spot” or area that cooks with evenness and consistency for a specific product. Attempts have been made to “fine tune” this “sweet spot” by placing the racks at different heights, however, many conventional ovens still have a tendency to over cook or over brown the food product at the rear of the oven. This can be due to excessive air leaks in the oven door, excessive airflow over the product next to fan intake, or even opening the oven door multiple times to check on the product being baked.

### SUMMARY OF THE INVENTION

The present invention, in one of its most preferred embodiments comprises an oven structure which provides for two or more separate ovens separated by vertical, movable, hinged partition(s) whereby the oven structure may function as one large oven or as two or more smaller independent ovens, and which further provide for highly controlled heating of each cooking chamber by means of a tangential fan for each chamber with air flow therefrom directed over upper elctrical heating elements by means of flow director structure ensuring luminal flow and evenness of heat transfers, wherein the flow director also functions as a radiant heat shield or occluder which is operator movable to either expose or occlude the radiant heat to each chamber from the upper elements depending on the need to roast, bake, or broil the food product. Also provided are lower electrical heating elements positioned below ceramic cooking surfaces for ensuring evenness of radiant heat transfer therefrom. Also provided for is operator controlled top vs. bottom heating using a slide control that reciprocally affects the duty cycle of the top and bottom electrical heating elements, further allowing precision baking control.

The present oven structure design addresses the aforementioned prior difficulties and in addition, the design concept extends the side walls of the oven and diminishes the vertical oven height, and provides a hinged moveable vertical partition to enable the operator to vary the cooking chamber size for smaller or larger products. This allows for the oven to be employed as a single larger oven or as two or more smaller ovens. Also, independent controls for these partitioned cooking chambers enable the user to perform independent cooking tasks in each separate cooking chamber.

An even heat transfer is the hall mark of precision baking and is probably more important than the method of transfer (radiant, convective, conductive). This issue is addressed through the present invention by a number of changes or departures from the standard. For example, with the present invention, convective heat is provided by a tangential fan positioned in the rear top of the oven that blows air along its entire length. The inlet air is ducted to the fan from the bottom of the back wall of the cooking chamber and the outflow air is controlled by a flow director that channels the heated air along the top of the oven over the heating elements and down into the cooking chamber resulting in an even laminar air flow.

The flow director is constructed to function also as a radiant heat occluder to either block or expose the cooking product to direct radiant heat from the upper heating elements depending on the cooking task desired. For example, the air flow director can serve as a radiant shield for the top elements, thereby ensuring evenest in heating but can be repositioned to expose the top heating elements to the food product as would be necessary, for example for broiling. Bottom heat is provided by heating elements preferably beneath a large ceramic plate which forms the floor or bottom wall of the oven cooking chamber on which plate the food product may be placed either directly as with bread or indirectly as in a cooking vessel. The ceramic or metal plate functions as a heat sink and radiates heat evenly. A ceramic plate is preferred since it is a poor heat conductor and thus prevents burning of the bottom of the food product.

All of the above features of the present invention, in combination, ensure an even heat distribution to the food product. Also, the ultimate in precision baking is the ability to reciprocally adjust the heat delivery from upper and lower heating elements of each oven. This is accomplished by the present invention by means of, e.g., a slide switch (variable resistor) and an appropriate electrical circuit that increases or decreases the cycle time to the upper and lower heating elements in a reciprocal fashion. For example, adjusting the switch upwardly would concomitantly increase the duty cycle of the upper elements and decrease the duty cycle of the lower elements. Preset temperature would be maintained thereby but the top of the product would be exposed to more heat, much like moving the conventional oven rack up or down. Examples would be cooking a steak with the slide switch in the full up position with the heat being generated exclusively by the upper elements such as to effect broiling. In cooking a pizza for example, the switch would be far down to effectively brown the crust.

The present ovens can be mounted under shelf or over shelf top with appropriate venting provided. This makes the baking process more convenient in minimizing bending or stooping and allows the user to more easily produce the exact “brownness” of the cooked products especially breads, particularly where the provision of a large glass door enhances visualization.

### BRIEF DESCRIPTION OF DRAWINGS

The present invention will be understood further from the following description and drawings wherein certain structures are shown in exaggerated dimensions for purposes of clarity, wherein the figures are not in structural proportion to each other, wherein their structural appearance in the drawings does not, in any way, restrict their methods of manufacture, and wherein:

FIG. 1 is a frontal isometric view of the present oven with the oven divider or partition and front access door removed for clarity;

FIG. 2 is a cross-sectional view of the oven in FIG. 1 taken along line 2-2 therein;

FIG. 3 is a cross-sectional view taken alone line 3-3 in FIG. 2;

FIG. 3A is an enlarged cross-sectional view of the dotted area in FIG. 3;

FIG. 4 is an isometric cross-sectional view taken along line of FIG. 1;

FIG. 4A is a longitudinal cross-sectional view of a typical tangential fan;

FIG. 5 is a cross-sectional taken along line 5-5 in FIG. 3 depicting circulating air flow paths and a non-blocking position of a portion of the occluder slide plate;

FIG. 6 is a cross-sectional view taken along line 6-6 in FIG. 3;

FIG. 7 is an isometric plan view of the heat radiation shielding or blocking occluder slide plate of FIGS. 5 and 6;

FIG. 8 is a cross-sectional view taken along the axis of a portion of the upper heating cavity and the axis of the two circulating fans showing a coaxial drive mechanism for selectively operating the separate fans;

FIG. 9 is a cross-sectional view as in FIG. 8 showing a clutch type of driving means for the separate fans;

FIG. 10 is a variation of the clutch engaging faces of FIG. 9; and

FIG. 11 is a schematic electrical circuit for operating the present oven structure by reciprocating balance of the heat output of the upper and lower heating elements.

### DETAILED DESCRIPTION

Referring to the drawings the present cooking oven structure comprises a single or side by side multiple ovens, wherein each oven comprises spaced inner 10 and outer 12 metal housings formed respectively by first wall means 11 and second wall means 13. First wall means 11 provides the structural elements of a ceiling 14, a floor 18, opposing side walls 22, 24, a back wall 30, and front wall portions 34 provided with a hinged access door 38. An upper heating cavity 45 and a circulating air feed channel 47 combination generally designated 39 is formed by third wall means 41 having a generally horizontal upper section 43 spaced inwardly from ceiling 14 and by a general vertical side section 49 spaced inwardly from the back wall 30 of the inner housing.

A heat sink ceramic or steel plate means 44 is adapted to provide a predeterminable heat supply and is spaced upwardly from floor 18 and forms with wall means 11 a lower heating cavity 16. Section 49 is spaced upwardly from plate means 44, e.g., 0.5-2.0 in. to provide a circulating air inlet 19 to channel 47. These structural elements of the inner housing, third wall means and ceramic plate define a cooking chamber 40.

The outer housing 12 and second wall means 13 comprises a top or ceiling 91, end (side) walls 92, 93, floor 94 back wall 95, and front wall portions 34 which interconnect the front perimeter portions of the inner and outer housings. A typical set of dimensions for the present oven structure for dual ovens are as follows:

| | |
|---|---|
| (a) oven structure outside width | 36.0″ |
| (b) oven structure outside depth | 17.2″ |
| (c) oven structure outside height | 12.0″ |
| (d) oven structure interior width | 30.0″ |
| (e) oven structure interior depth | 14.0″ |
| (f) oven structure interior height | 9.0″ |

The center partition means 79 hinges back against the back wall to create an enlaged cooking chamber approximately 30 in. wide, 14 in. deep and 9 in. high. Heat insulation material 42 such as glass wool is positioned between said housings in conventional manner.

A first electrical resistance heating means 46 for plate means 44 is positioned under the plate within lower heating cavity 16. A second electrical resistance heating means 48 is positioned under ceiling 14 within upper heating cavity 45. Heat radiation shielding means generally designated 50 is positioned between heating means 48 and upper section 43 of said third wall means. This shielding means 50 comprises base ledges 51 formed from grooves 52 in the side walls 22, 24, and a slide plate 53 formed with air flow slots 54 providing shielding lands 55. Plate 53 is slidably supported on the base ledges 51 and is operator slidable with respect to heating coils or the like 48 between a heat radiation blocking position 56 (FIG. 3) and a heat radiation non-blocking position 58 (FIG. 3) with respect to said cooking chamber.

An air flow circulating fan 60 communicating with the cooking chamber 40 and the upper heating cavity 45 is adapted to cycle (circulate) air from the cooking chamber into the air feed channel 47 thru inlet 19, into upper heating cavity 45, over the heating elements 48, down into the cooking chamber thru slots 54, and across plate means 44 and into inlet 19.

The housings 10 and 12 are of conventional construction such as, e.g., 14-26 gauge sheet steel which can be ceramic glazed or otherwise coated with high temperature resistant paint or the like material. In the drawings the structures appear as thick monolithic castings for purposes of clarity, however the sheet metal joints can be made by conventional techniques of welding, brazing, metal interlocking crimping, rivets, sheet metal screws or the like.

A steam injection system such as shown and described in U.S. Pat. No. ______ is preferably used with the present invention and is show in FIG. 6 as a water inlet tube 91 extending between walls 11 and 13 and connected to a tube 92 containing stainless steel balls 93. A conventional oven light 94 is set into the oven side wall.

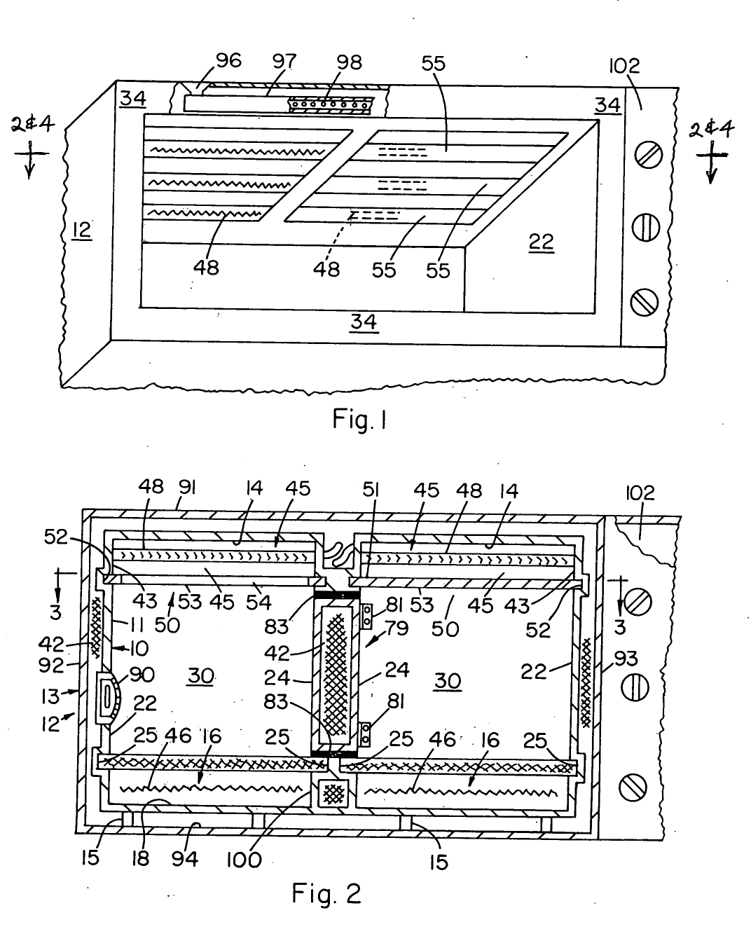

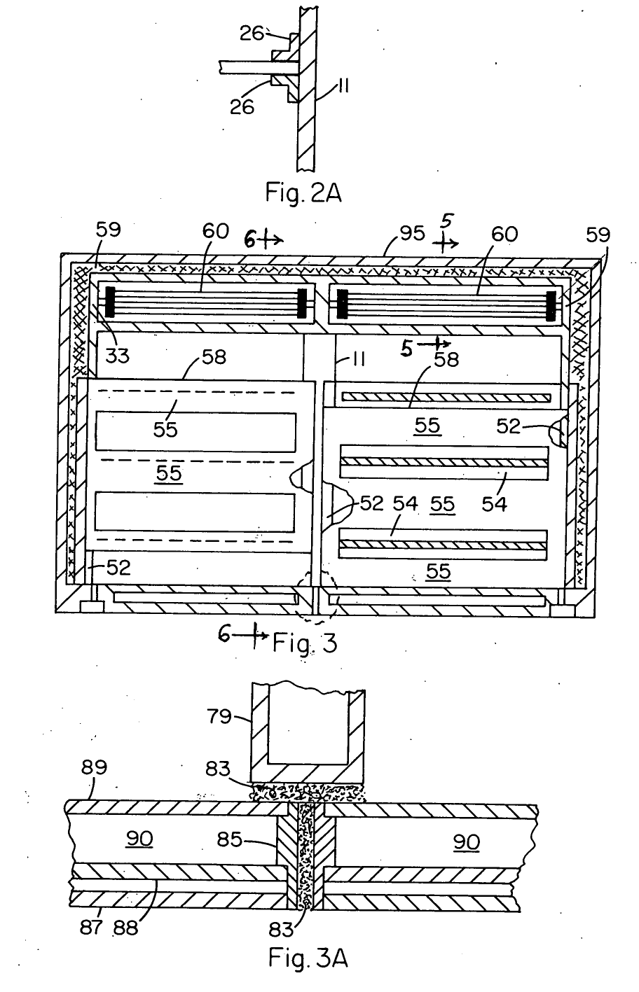

As shown in FIG. 2, metal spacers 15 or an equivalent structure can be placed and fixed strategically to the inner and outer housings to maintain a rigid spacing and connection between the two and for providing a dimensioned space for containing the insulation material 42. Side walls 22 and 24 are shown as grooved as at 52 and 25 for supporting slide plate 53 and heat sink plate means 44 respectively, however other structures such as elongated metal or ceramic angle members 26 welded or riveted to first wall means 11 as shown in FIG. 2A may be employed.

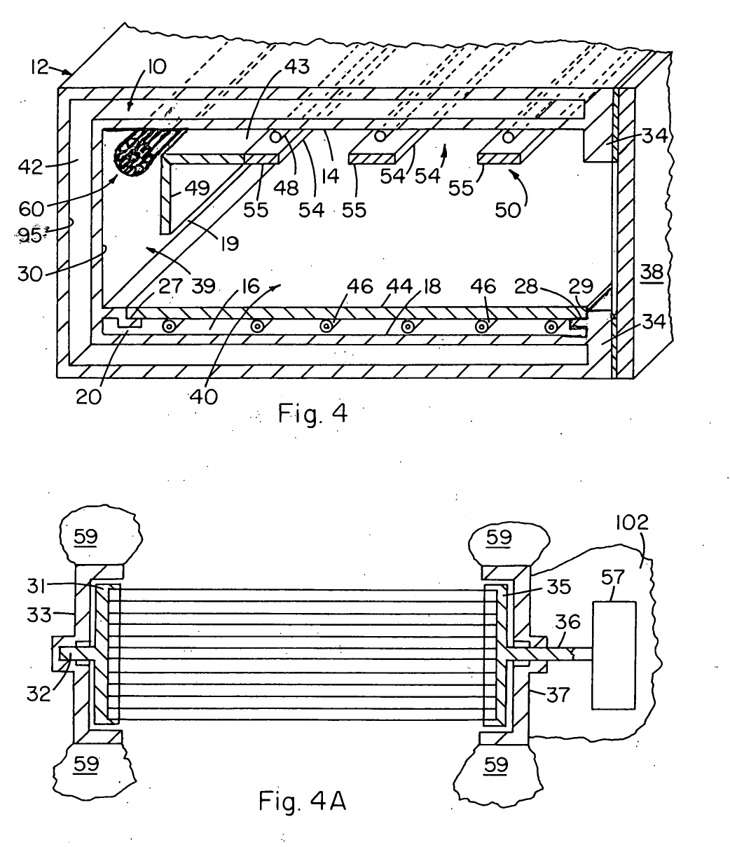

Referring to FIG. 4, the ceramic plate rear support 20 comprises a lateral ledge such as 27 at the back of the cooking chamber and 28 at the front thereof It is noted that the shallow ledge 28 allows the plate to be slid into grooves 25 if there is sufficient looseness in the fit of the plate therein such as to accommodate the small drop down 29. This structure locks the plate horizontally in place. The ceramic plate preferably consists of and has a thickness of from about to about in.

Each heating means 46 and 48 and thermocouple sensors therefor can be selected from any commercially available types including the finned or tubular heaters and thermocouples as described in the 1999-2005 Watlow Electric Manufacturing Company brochures from WATLOW, 5710 Kenoshat Street, Richmond, Ill. 10071. The doors and handles can be selected, for example, from those shown in the Jun. 23, 2005 brochures of Mills Products, Incorporated, 219 Ward Circle, Suite 2, Brentwood, Tenn. 37027.

The air circulating fan 60 most preferably is a cross flow or tangential blower type as described in the Jun. 23, 2005 brochure of EUCANIA International, Inc. Such fans give an even laminar air flow from back to front substantially completely across (side to side) of the present oven which greatly facilitates temperature control by the present invention throughout the oven cooking chamber.

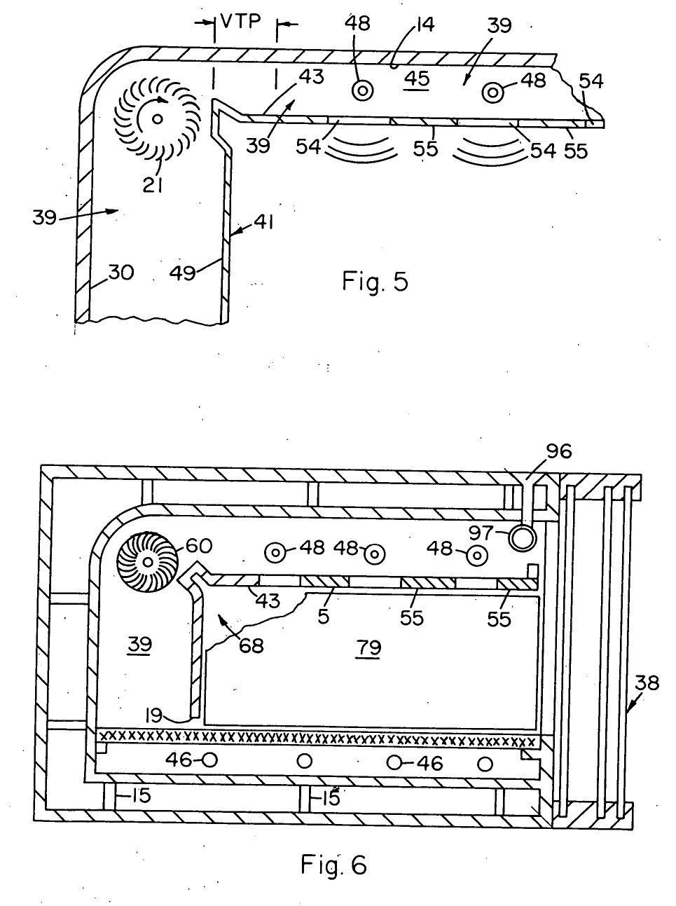

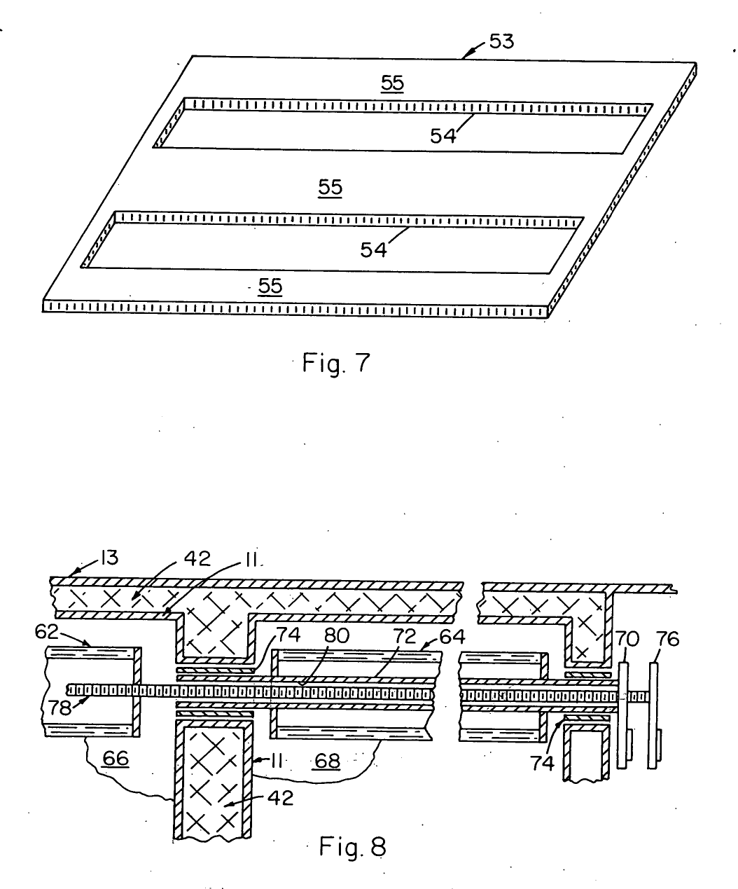

An example of these fans for use in the present invention, referring to FIGS. 3, 4, 4A and 5, comprises a plurality, e.g., 10-30 elongated blades 21 of about 18 in. length and about ⅜-¼ in. width as shown in FIG. 5 and having a radiual curvature and fixed in a circle of about 1.6 in. OD at one end into a disc 31 having a shaft 32 which is rotatably mounted in a bearing housing 33. The other end of the blades are fixed into a disc 35 having a shaft 36 which is rotatably mounted in a bearing housing 37. Shaft 36 comprises, e.g., the output shaft of an electrical motor 57. Bearing housing 33 and 37 are attached to and fixed in position relative to each other by wall means 11 such as portions 59 thereof into which shafts 32 and 36 are respectively mounted. It is noted that where the oven dimensions require long, e.g., 18 in. tangential fans, supporting discs preferably are used to support the blades and fix them in position relative to each other in the middle or other intermediate positions of their length. In order for the fan to have its maximum efficiency, the most preferred configuration for upper wall section 43 is shown in FIG. 5 wherein the fan outlet side is adjacent a vortex tongue portion of 43 delineated “VTP”.

Referring to FIG. 8 which is an exploded view for clarity, two tangential fans 62, 64 are used for the two oven chambers 66 and 68 respectively. The drive motor 70 for fan 64 has a tubular drive shaft 72 fixed to the fan disc ends and rotatably mounted in bearings 74 fixed in first wall means 11. The drive motor 76 for fan 62 has drive shaft 78 fixed to the fan disc ends and rotatably mounted thru the bore 80 of shaft 72.

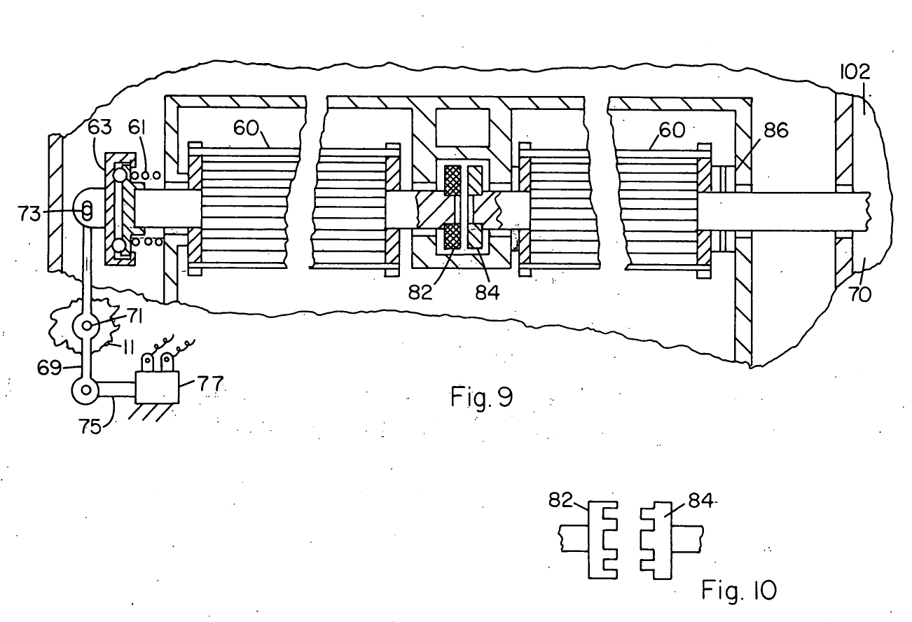

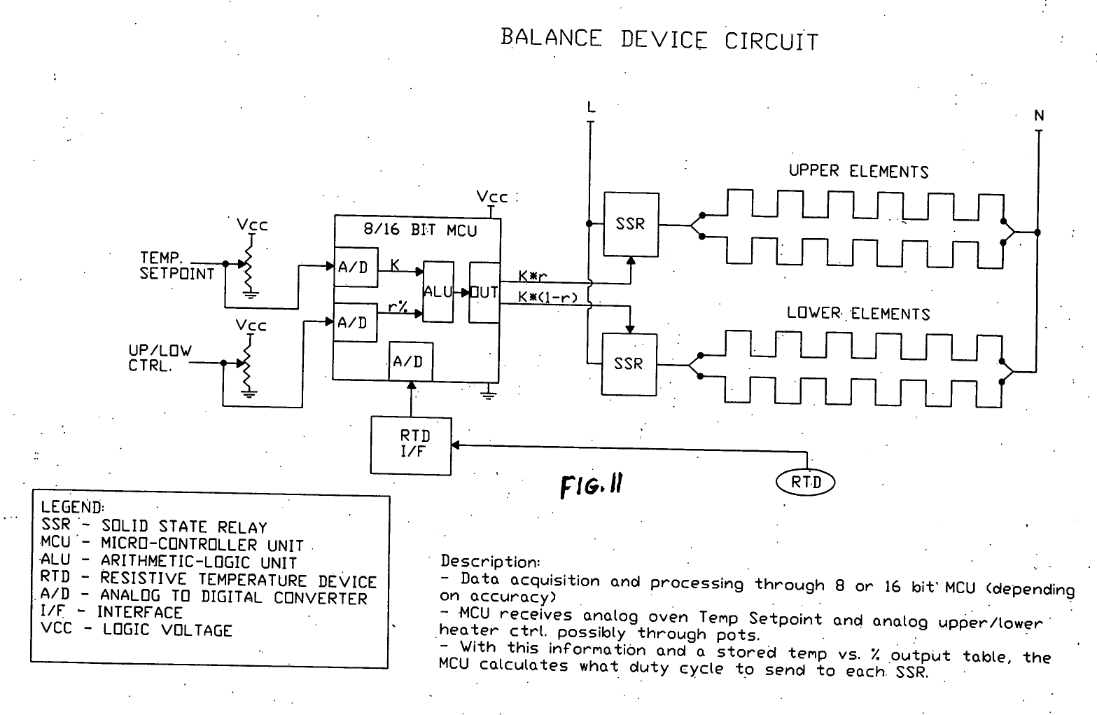

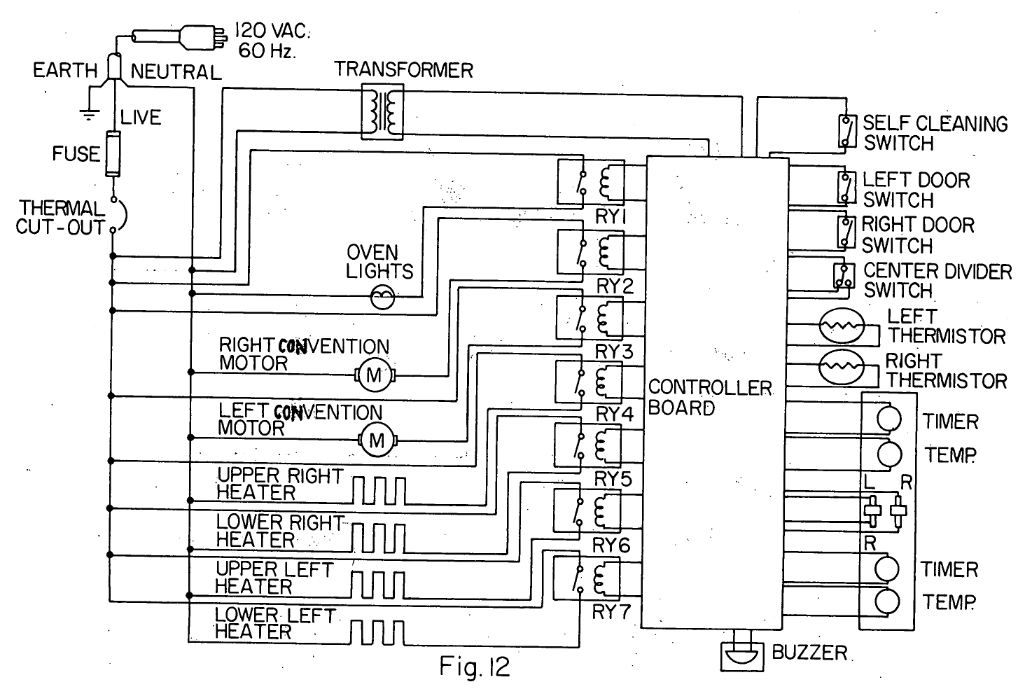

Referring to FIGS. 9 and 10 the separate fans of separate ovens are clutch driven by clutches of FIG. 9 or FIG. 10 or any other conventional clutch faces. In this embodiment equivalent structures to those of FIGS. 3, 4, 4A and 5 are numbered the same.

In FIG. 9, the adjacent ends of the drive shafts are provided one with a friction clutch disc 82 and the other with, e.g., a smooth steel faced disc 84. In this fan drive version, a thrust bearing 86 is provided to reduce endwise friction when the clutch is engaged. A comparison spring 61 and thrust bearing 63 are provided to ensure release of the clutch when only on fan is to be operated. The clutch is actuated to drive both fans by means of a lever 69 pivotally mounted at 71 to a stationary portion of the oven and at 73 to thrust bearing 63. Lever 69 may be connected to the armature 75 of a solenoid 77 incorporated, e.g., into the electronic control system for the oven. Alternatively, the lever may extend outwardly thru the oven front for manual operation.

Referring to FIGS. 2 and 3, a partition means generally designated 79 providing aforesaid side walls 24 is mounted on back wall 30 by hinges 81 of any convenient type such that it can be swung back against wall 30 by a user when it is desired to use a single larger cooking chamber. This partition means preferably is hollow core as shown containing heat insulation material 42. Strips 83 of firm heat insulation adhesive material can be used along the top, bottom, front and rear of the partition to assist in isolation of the two chambers as desired. The strips can be held in place by conventional mechanical means.

Referring to FIG. 3A the oven doors 38 most preferred comprise a frame 85 surrounding and fixed to an outer glass panel 87, a middle glass panel 88, and an inner glass panel 89. The cavity 90 is vented to protect against excessive heat generated air pressure. A strip such as 83 can be affixed to one or both doors. Conventional hinge means and latching means for the door are employed.

The invention has been described in detail with particular reference to preferred embodiments thereof, but it will be understood that variations and modifications will be effected with the spirit and scope of the invention.

I claim:

1. A cooking structure having a single or side by side multiple ovens, wherein each oven comprises, first wall means forming an inner housing, second wall means forming an outer housing spaced from said inner housing, each said housing comprising the structural elements of a ceiling, a floor, opposing side walls, a back wall, and a front wall provided with an access door, third wall means having an upper generally horizontal wall section spaced downwardly from said ceiling of said inner housing, and a generally vertical side wall section spaced inwardly from a side wall of said inner housing, said horizontal section housing aperture means therethrough to allow circulating air flow therethrough and said side wall section having air inlet means at a lower portion thereof, said wall sections in conjuction with said first wall means providing the combination of an upper downstream heating cavity and an upstream circulating air channel, plate means providing a heat sink and spaced upwardly from said floor and forming a lower heating cavity, wherein said structural elements of said inner housing, third wall means and plate means delimiting a cooking chamber, a first electrical resistance heating means for said plate means positioned under said plate means within said lower heating cavity, a second electrical resistance heating means positioned under said ceiling of said inner housing within said upper heating cavity, heat radiation shielding means positioned between said second electrical resistance means and said upper section of said third wall means and being operator moveable with respect to said second electrical resistance means and said aperture means between a heat radiation shielding and a non-shielding position with respect to said cooking chamber, and air flow circulating means communicating with said cooking chamber and said combination and adapted to cycle (circulate) air from said cooking chamber into said air channel, then into said upper heating cavity, then over said second electrical resistance heating means, and then down into said cooking chamber thin said aperture means and across said plate, and then thru said inlet means into said air channel.

2. The cooking structure of claim 1 wherein electrical control means is provided for adjusting the heat output of each of said first and second electrical resistance heating means.

3. The cooking structure of claim 2 wherein said control means automatically adjusts said heat output of said first and second heating means in a reciprocable manner.

4. The cooking structure of claim 2 wherein control means is provided for regulating air flow volume from said circulating means.

5. The cooking structure of claim 1 wherein said air flow circulating means comprises a tangential convection fan mounted in said upper heating cavity adjacent to the conjunction of said ceiling and said back wall of said inner housing with the rotation axis of said fan being substantially parallel to said back wall and said ceiling.

6. The cooking structure of claim 5 comprising two side by side ovens having unitary ceiling, floor, front wall and back wall elements and having a common side wall element comprising a partition means which divides the two ovens and which is hingedly mounted on said unitary back wall whereby said divider wall can be hinged back against said unitary back wall to provide a single enlarged cooking cavity.

7. The cooking structure of claim 6 wherein the fan of each oven is driven by a separate and independently operable electric motor.

8. The cooking structure of claim 6 wherein the fan of each oven is adapted to be driven by a single electric motor and wherein a clutch mechanism is provided for an operator to selectively drive one or both of said fans with said motor.
